(19) United States
(12) Patent Application Publication
(10) Pub. No.: US 2021/0390818 A1
(43) Pub. Date: Dec. 16, 2021

(54) AUTOMATIC VENDING MACHINE FOR BOXED FROZEN AND HOT FOOD

(71) Applicant: SUN-WAY SHUE, NEWARK, CA (US)

(72) Inventor: SUN-WAY SHUE, NEWARK, CA (US)

(21) Appl. No.: 16/898,455

(22) Filed: Jun. 11, 2020

(51) Int. Cl. G07F 17/00; G07F 11/16; G07F 9/10; G07F 11/48; G07F 5/26

(52) U.S. Cl. CPC G07F 17/0078; G07F 11/165; G07F 5/26; G07F 17/0071; G07F 11/48; G07F 9/105

(57) ABSTRACT

An automatic vending machine for boxed frozen and hot food includes a cupboard, a refrigeration device, racks, an oven, a robotic picking system, a feeding slot and a conveyor board. The refrigeration device and the oven are installed in a first accommodation space and a second accommodation space of the cupboard respectively, and the interior of the first accommodation space is formed into a placing space by a rack for putting food boxes. The robotic picking system picks one of the food boxes and moves it sideway into the oven for heating, and a moving tray in the oven and the conveyor board move the food box into the feeding slot in a seesaw gravitational sliding manner for delivery.

### BACKGROUND

### Technical Field

The present disclosure generally relates to the field of vending machines. More particularly, the present disclosure relates to an automatic vending machine for boxed frozen and hot food having both refrigeration and heating functions and using a robotic picking system to move a food box to an oven, and the food box is heated by the oven and then transmitted by a gravitational sliding method with a seesaw design. As a result, this disclosure has the effects of turning and transferring the food box and simplifying the mechanical parts of the machine.

### Description of Related Art

In general, most common vending machines on the market are used to sell cold and hot beverages. Since the beverages are usually packaged with a thermally conductive material such as a metal, therefore the refrigeration and heating structure is relatively simple and the conveying method is to simply arrange the beverages in a straight line and allow them to drop to an outlet by gravity. However, in recent years, the products sold by the vending machine have gradually diversified from packaged products such as beverages and biscuits to other food items need to be heated, and these food items are pre-cooked and stored in appropriate containers. To preserve the freshness of the food, the vending machines of this sort also change the packaging method of the food and come with a refrigeration device to prevent food deterioration, a heating device for packaged meal, and a food conveying device for allocating the stored food and transferring the food inside the machine. In addition, these vending machines further include a cash register device for transaction and payment processing.

In the aforementioned vending machines that sell cooked food, the internal storage space of the machine and the design of the food conveying device are limited by the volume, shape, and size of the food container. Unlike the design of beverage vending machines that delivers a beverage by a free-fall method, the food items cannot be delivered by using the free-fall method, but most of them are delivered by adopting the design of a conveyor belt with a lifting device, and these components also occupy some of the storage space and make the originally small storage space even smaller. Furthermore, the space for storing food is designed according to the shape of the container, and thus cannot be used for storing other containers of different shapes and sizes. In addition, these food items need to be heated by the heating device, and the conventional refrigeration device and the heating device are usually installed in the same space. Although there is a protective measure to prevent the refrigeration and heating devices from interfering with one another, yet the issue of interference cannot be overcome effectively. The food conveying device for conveying food usually has to move and turn the food continuously, so that the structure of the food conveying device is relatively complicated, and the maintenance and repair of the food conveying device incurs a higher level of difficulty and a higher cost.

In view of the aforementioned drawbacks with regard to food allocation, and refrigeration and heating functions of the conventional vending machine, the discloser of the present disclosure designed an automatic vending machine for boxed frozen and hot food that uses a robotic picking system capable of moving in three axes to move a food box from its original stored position to an oven for heating, and the vending machine has a passage between the space for cold storage and the space for placing the oven, so that the cold and hot energies on both sides will not interfere with each other. In addition to the use of the robotic picking system for delivery, this disclosure also uses the gravitational sliding method with the seesaw design for conveyance and thus has the effects of turning and transmitting the food boxes and simplifying the mechanical parts of the vending machine. Since the robotic picking system can be moved in the directions of two axes, the food boxes can be stored and stacked vertically on top of one another, and the storage will not be limited so much by the size of the food boxes.

### SUMMARY

Therefore, it is a primary objective of the present disclosure to provide an automatic vending machine for boxed frozen and hot food, and this machine uses a robotic picking system to pick a food box which is vertically stacked in a storage space and the food box is moved sideway to the position of an oven which is installed in another independent space for heating, and a moving tray and a conveyor board are installed in the oven and provided for moving the food box to a feeding slot by a seesaw gravitational sliding method for delivery. With a high density capacity and a large storage capacity, products of different sizes can be adjusted quickly and conveniently for various compatible uses. In addition, the mechanism of the present disclosure has a simplified and separated design, so that the refrigeration and heating will not interfere with each other, and the cooling and heating efficiency can be improved, and the failure rate can be lowered.

To achieve the aforementioned and other objectives, the present disclosure provides an unmanned automatic packaged meal box vending machine, comprising: a cupboard, with an interior partitioned into a first accommodation space and a second accommodation space; a refrigeration device, disposed in the first accommodation space and the second accommodation space; a plurality of racks, installed in pairs into the first accommodation space to form a whole placing space, and a plurality of storage spaces between the two adjacent racks for placing at least one food box; an oven, disposed in the second accommodation space, and a receiving opening being formed between the first accommodation space and the second accommodation space, and the oven being installed on a side of the receiving opening and provided for heating the food box that is put into the oven, and the oven having a moving tray therein, and a surface of the moving tray having a plurality of sliding balls, and an electromagnet being installed to a front end of the moving tray for attaching the moving tray after the electromagnet is driven, so that the moving tray is situated in a tilted status;

a robotic picking system, installed in the first accommodation space and disposed on a side of the placing space, and the robotic picking system comprising a first-axis moving device, a second-axis moving device and a carrying board, and the second-axis moving device being installed on the first-axis moving device, and the carrying board being installed on the second-axis moving device, and the first-axis moving device moving horizontally parallel to the placing space, and the moving direction of the first-axis moving device and the moving direction of the second-axis moving device being perpendicular to each other, such that after the first-axis moving device drives the second-axis moving device to move to a position for removing the food box, the second-axis moving device drives the carrying board to move towards the food box in order to carry and place the food box onto the carrying board, and finally the second-axis moving device and the first-axis moving device move the food box to the receiving opening and then into the oven; a feeding slot, disposed in the second accommodation space and disposed on a side of the oven, for putting the heated food box; and a conveyor board, having a first side edge and a second side edge, and installed between the oven and the feeding slot, and normally keeping at an angle after the moving tray is tilted, wherein the first side edge is configured to be corresponsive to the moving tray, and the second side edge is configured to be corresponsive to position of the feeding slot for setting the feeding slot to an open/closed status, such that after the food box slides down from the moving tray to the conveyor board, the food box will continue to slide to a position of the second side edge, such that the feeding slot will be in the open status after the conveyor board is tilted, and after the food box falls into the feeding slot, the conveyor board will resume its original position and the feeding slot will be in the closed status.

In an embodiment, the receiving opening normally keeps a closed status, and after the receiving opening is opened, a tilt angle over 15 degrees occurs, and when the food box touches the receiving opening, the food box props open the receiving opening into a tilt state and slides into the oven. In addition, the robotic picking system moves in a direction towards the receiving opening and this direction is perpendicular to the direction of sending out the food box from the oven. The oven has a heating device installed thereon, and the moving tray is installed under the heating device, and a first rotary shaft is disposed at the bottom of the center of the moving tray, so that the moving tray can swing in a direction of sending out the food box by using the first rotary shaft as a fulcrum, and tilt after the electromagnet is attached to the moving tray. It is noteworthy that the moving tray has a positioning rope installed at a front end thereof and configured to be corresponsive to the electromagnet, and a first counterweight disposed on the other side of the moving tray, so that after the electromagnet is released from the attached state, the first counterweight and the positioning rope resume the moving tray to its original position. In the present disclosure, the conveyor board has a second rotary shaft installed at the center thereof, and a second counterweight is disposed under the first side edge, such that the second counterweight can use the second rotary shaft as a fulcrum to tilt the second side edge upwardly into a curved shape and abuts at an opening of the feeding slot to define a closed status, and when the food box slides along the conveyor board to a position near the second side edge, the conveyor board will be turned downwardly into an open status, so that the food box can fall into the feeding slot.

In another embodiment of the present disclosure, the feeding slot has an upper meal pickup opening and a lower meal pickup opening formed at a front side thereof and configured to be relative to the cupboard, and both sides of the feeding slot have a partition board, and each of the partition boards has a third rotary shaft and a third counterweight, and the two partition boards are provided for dividing the feeding slot into an upper area and a lower area, and after the food box falling into the lower area presses and squeezes the two partition boards by gravity, the two partition boards will be rotated by using the third rotary shaft as a fulcrum, so that the next food box falling into the feeding slot will be situated in the upper area, and after the food box is taken out, the two third counterweights resume the two partition boards to their original positions respectively.

In addition, the refrigeration device comprises a blowing device and a compressor, and the blowing device is disposed in the first accommodation space, and the compressor is disposed in the second accommodation space and at a position under the oven. The cupboard comprises a first door panel installed thereon and configured to be relative to the first accommodation space, and a second door panel installed thereon and configured to be relative to the second accommodation space, and the first door panel has anti-theft lock installed thereon, and the anti-theft lock is manufactured with a company nameplate and locked or unlocked by a concave and convex buckling method.

### BRIEF DESCRIPTION OF THE DRAWINGS

FIG. 1 is a first schematic view showing the structure of a preferred embodiment of the present disclosure;

FIG. 2 is a second schematic view showing the structure of a preferred embodiment of the present disclosure;

FIG. 3 is a perspective view of a preferred embodiment of the present disclosure;

FIG. 4 is a schematic view showing the status of removing a food box in accordance with a preferred embodiment of the present disclosure;

FIG. 5 is a schematic view showing the status of conveying a food box in accordance with a preferred embodiment of the present disclosure;

FIG. 6 is a schematic view showing the status of sending a food box to an oven in accordance with a preferred embodiment of the present disclosure;

FIG. 7 is a schematic view showing the status after heating a food box in accordance with a preferred embodiment of the present disclosure after a food box is heated;

FIG. 8 is a first schematic view showing the status of operating a conveyor board in accordance with a preferred embodiment of the present disclosure;

FIG. 9 is a second schematic view showing the status of operating a conveyor board in accordance with a preferred embodiment of the present disclosure;

FIG. 10 is a schematic view showing the status of operating partition board in accordance with a preferred embodiment of the present disclosure; and

FIG. 11 is a schematic view showing the status of operating an anti-theft lock in accordance with a preferred embodiment of the present disclosure.

### DESCRIPTION OF THE EMBODIMENTS

To make it easier for the examiner to understand the structure, technical characteristics and overall operation of this disclosure, the specification accompanied by the drawings is described as follows.

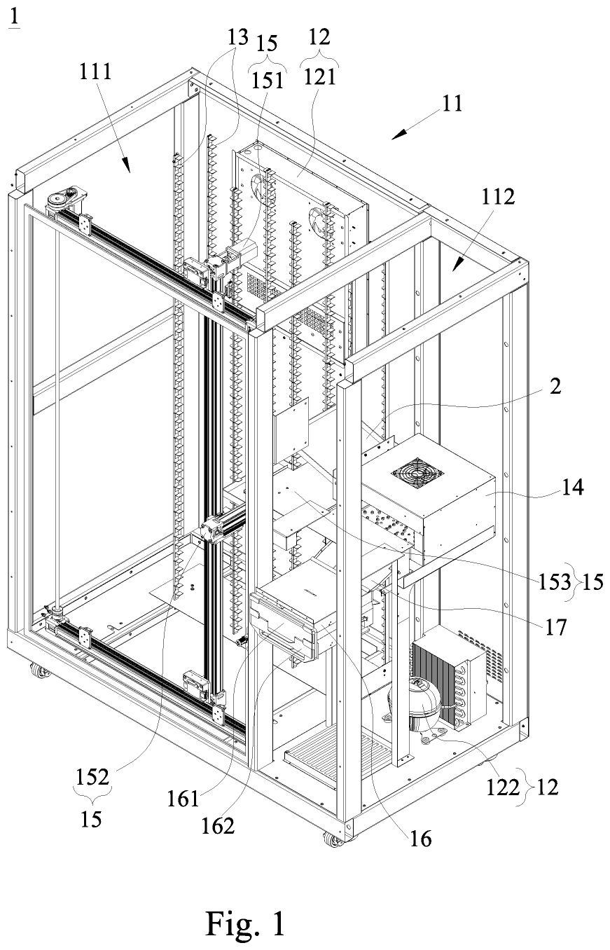

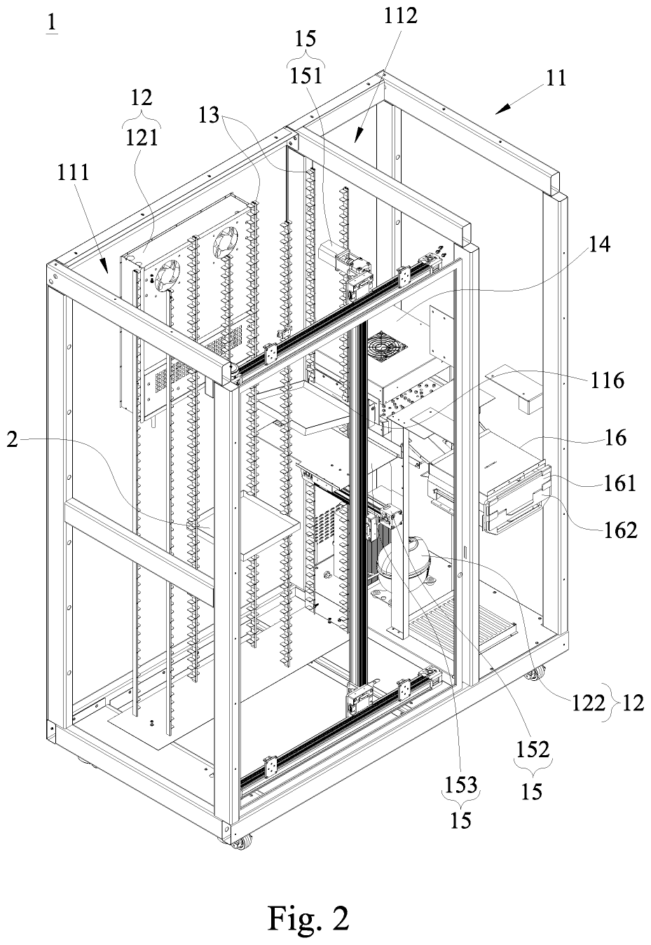

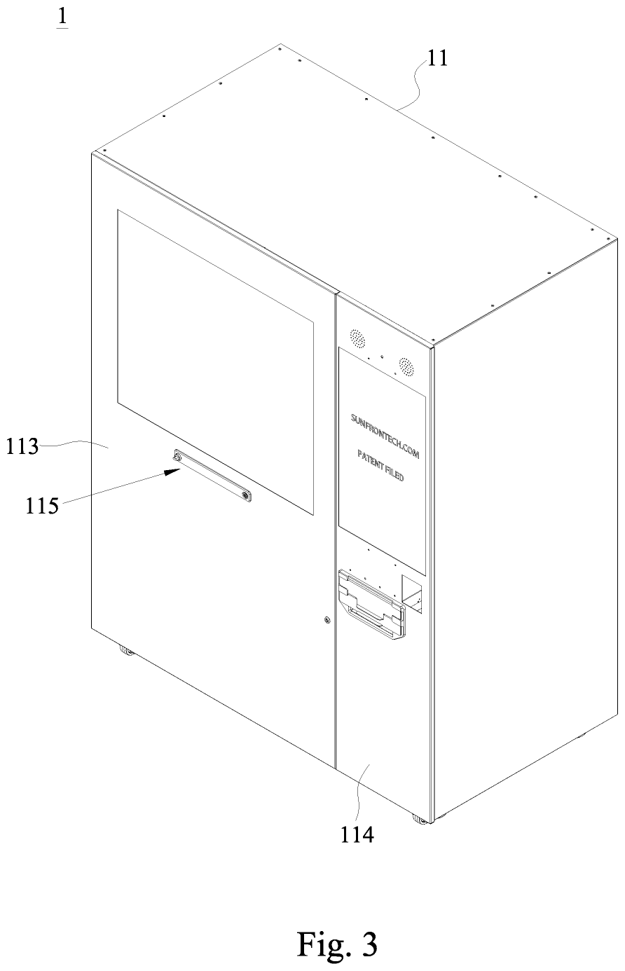

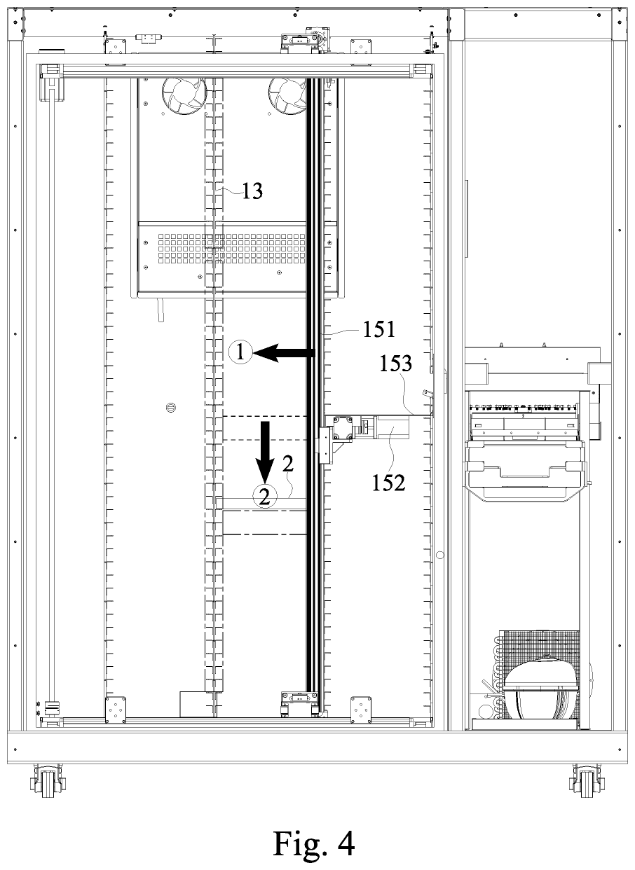

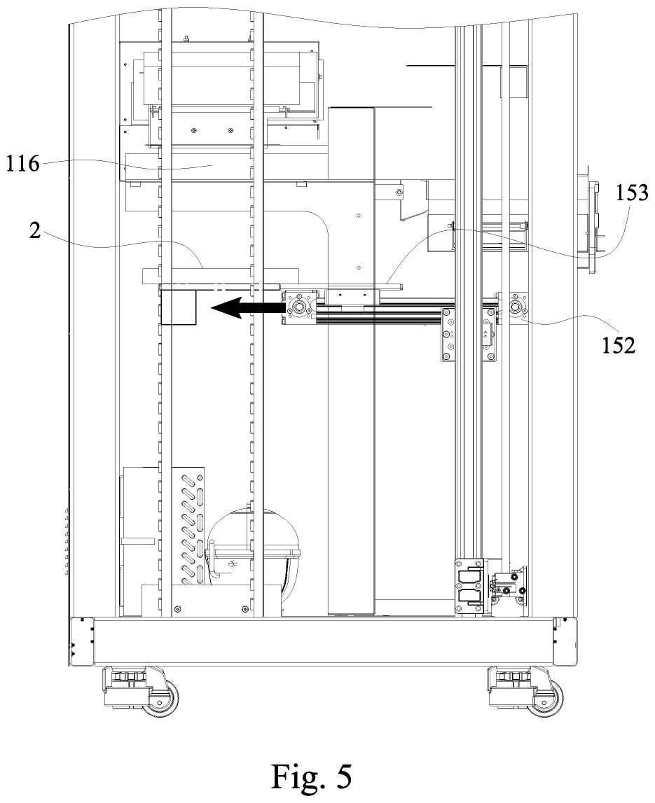

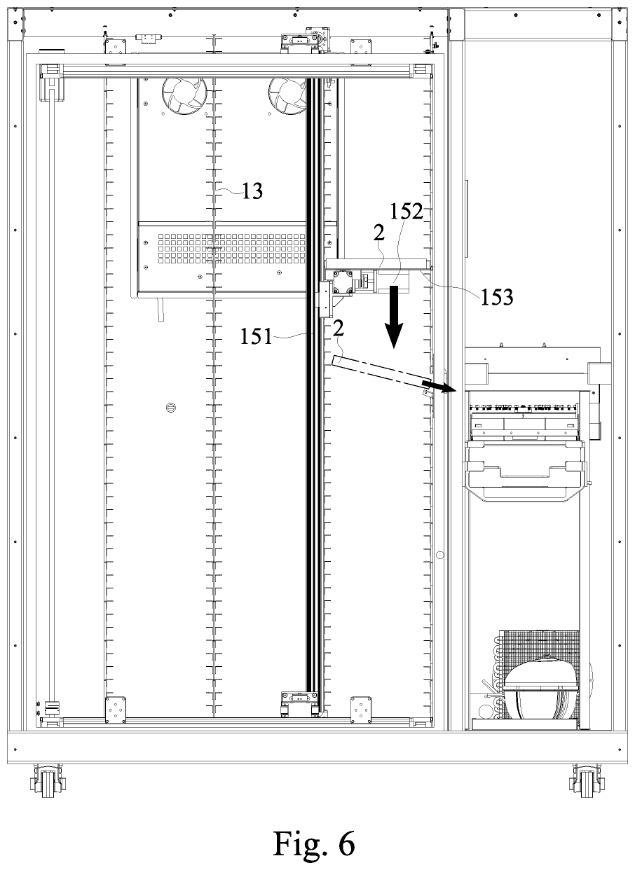

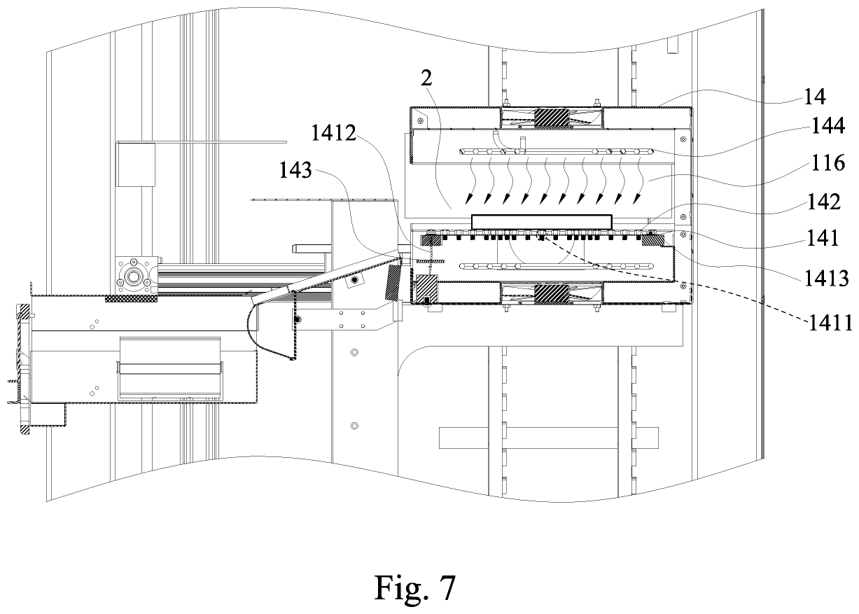

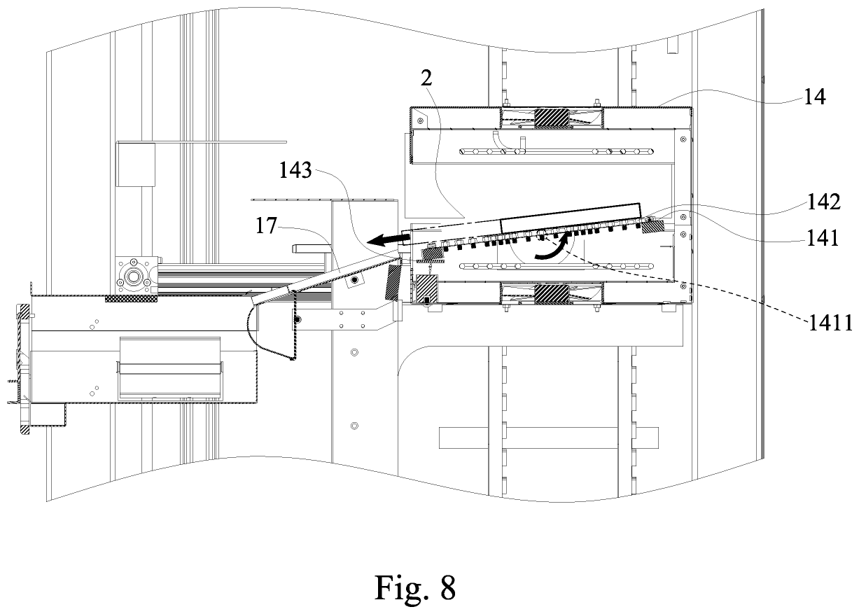

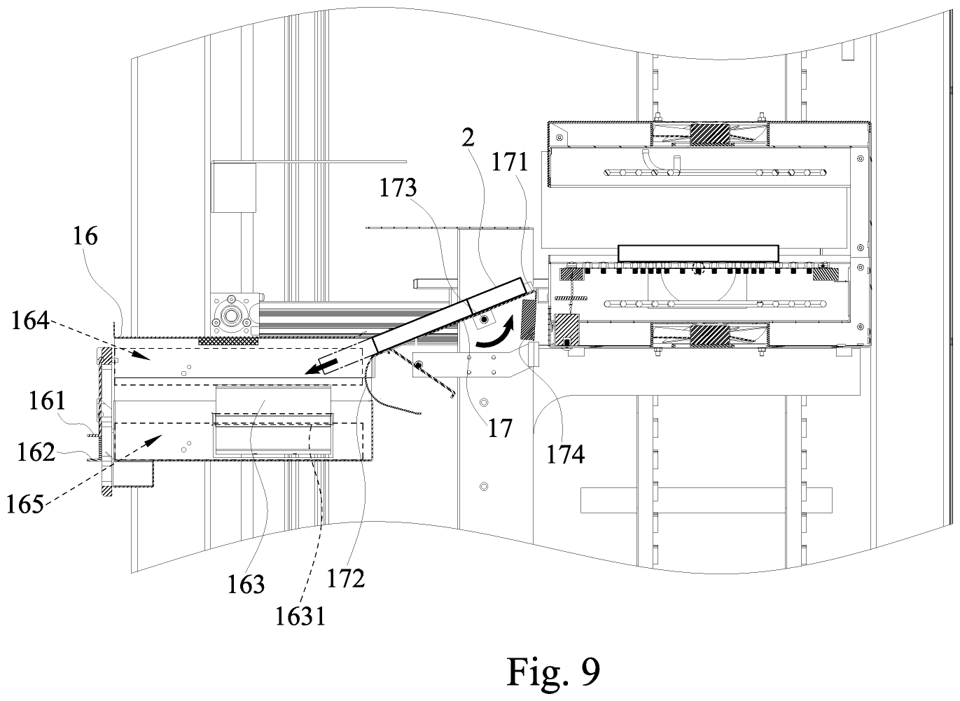

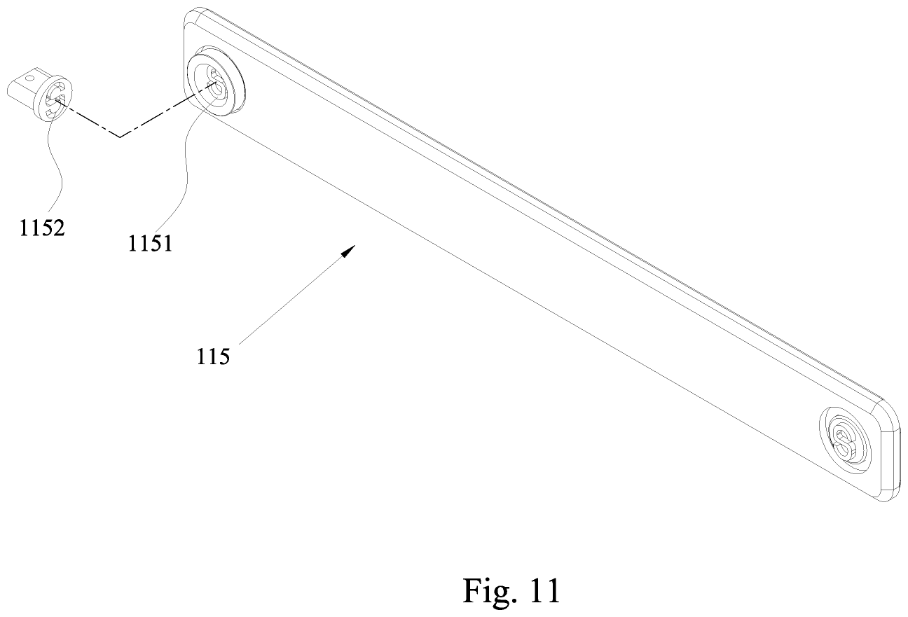

With reference to FIGS. 1, 2 and 3, and 4 to 11 for different schematic views and perspective views of a preferred embodiment of the present disclosure and schematic views of different operating statuses in accordance with a preferred embodiment of the present disclosure respectively, an unmanned automatic packaged meal box vending machine 1 of the present disclosure as shown in FIGS. 1 and 2 comprises a cupboard 11, a refrigeration device 12, a plurality of racks 13, an oven 14, a robotic picking system 15, a feeding slot 16 and a conveyor board 17.

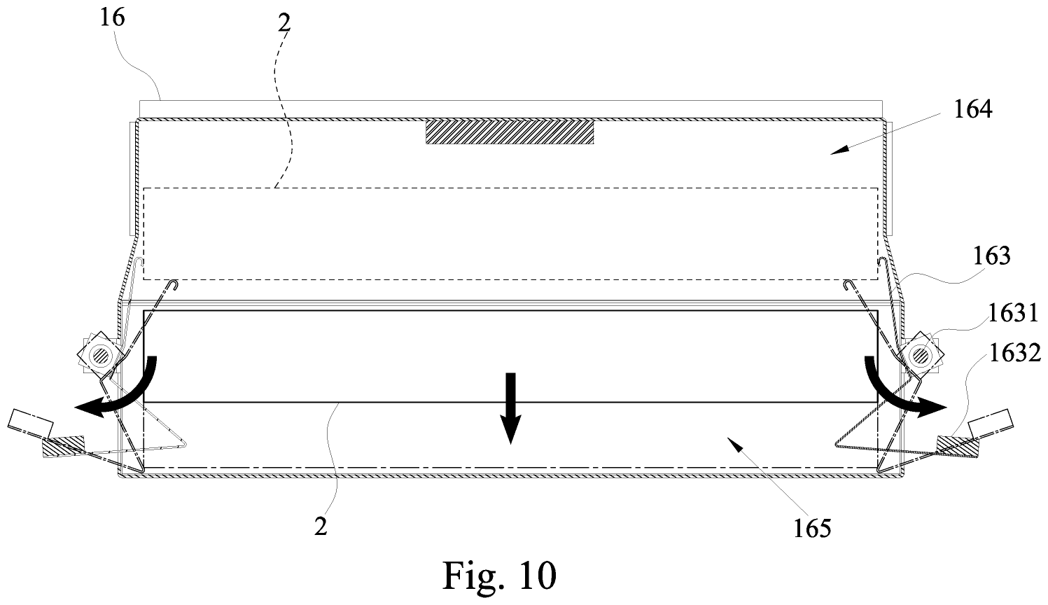

The interior of the cupboard 11 is divided into a first accommodation space 111 and a second accommodation space 112. It is noteworthy that the cupboard 11 has a first door panel 113 installed thereon and configured to be relative to the first accommodation space 111 and a second door panel 114 installed thereon and configured relative to the second accommodation space 112, and the first door panel 113 (particularly a product import port) has an anti-theft lock 115, and the anti-theft lock 115 is manufactured with a company nameplate for covering the product import port, and the anti-theft lock 115 is locked and unlocked by a concave and convex buckling method. After the anti-theft lock 115 is unlocked, an end of the anti-theft lock 115 can be rotated by 90 degrees and drooped, so that the anti-theft lock 115 is situated in a single-sided hanging mode, and the product import port can be opened for inputting products as shown in FIG. 10, and the anti-theft lock 115 has a head 1151 which is a substantially S-shaped groove, and a key 1152 which is a substantially S-shaped bump, and the two can be combined or buckled to achieve the locking/unlocking effect.

The refrigeration device 12 comprises a blowing device 121 and a compressor 122, and the blowing device 121 is disposed in the first accommodation space 111, and the compressor 122 is disposed in the second accommodation space 112.

The racks 13 are arranged in pairs and disposed in the first accommodation space 111 to form a whole piece of placing space with a plurality of storage spaces 131 formed between the two adjacent racks 13 for placing or storing at least one food box 2, so that the food boxes 2 can be stacked vertically with respect to each other.

The oven 14 is disposed in the second accommodation space 112, and a receiving opening 116 is formed between the first accommodation space 111 and the second accommodation space 112, and the oven 14 is installed on a side of the receiving opening 116 and provided for putting in the food box 2 for heating, and the receiving opening 116 adopts a gravitational pulling-back door panel design, so that the receiving opening 116 will be opened automatically after being pushed and squeezed by the food box 2, and the receiving opening 116 will resume its original closed status after the food box 2 passes through the receiving opening 116. In addition, the oven 14 has a moving tray 141 therein, and a surface of the moving tray 141 has a plurality of sliding balls 142, and an electromagnet 143 installed at the front of the moving tray 141. After the electromagnet 143 is driven to attach the moving tray 141, the moving tray 141 is in a tilt status. It is noteworthy that the receiving opening 116 normally keeps its closed status, and after the receiving opening 116 is opened, a tilt angle over 15 degrees occurs, and when the food box 2 touches the receiving opening 116, the food box 2 can prop open the receiving opening 116 into a tilt status and slide into the oven 14. In addition, a heating device 144 is installed above the oven 14, and the moving tray 141 is placed under the heating device 144, and a first rotary shaft 1411 is installed at the center of the bottom of the moving tray 141, so that the moving tray 141 can swing in the direction of sending out the food box 2 by using the first rotary shaft 1411 as a fulcrum. After the electromagnet 143 is attached to the moving tray 141, the moving tray 141 is swung and tilted, and the front of the moving tray 141 has a positioning rope 1412 configured to be relative to the electromagnet 14, and the other side has a first counterweight 1413, and after the electromagnet 14 is released from attached status, the first counterweight 1413 and the positioning rope 1412 drive the moving tray 141 to resume their original positions. It is noteworthy that the swing direction of the moving tray 141 of the present disclosure is perpendicular to the direction of moving the food box 2 by the robotic picking system 15, so that the sliding balls 142 and the electromagnet 143 on the moving tray 141 can be used to turn the direction of conveying the food box 2 in 90 degrees.

The robotic picking system 15 is installed in the first accommodation space 111 and disposed on a side of the placing space, and the robotic picking system 15 comprises a first-axis moving device 151, a second-axis moving device 152 and a carrying board 153, and the second-axis moving device 152 is installed on the first-axis moving device 151, and the carrying board 153 is installed on the second-axis moving device 152, and the first-axis moving device 151 moves in horizontal direction parallel to the placing space, and moving direction of the first-axis moving device 151 is perpendicular to the moving direction of the second-axis moving device 152. After the first-axis moving device 151 drives the second-axis moving device 152 to move to a desired position for removing the food box 2, the second-axis moving device 152 drives the carrying board 153 to move towards the food box 2. After the carrying board 153 carries and puts the food box 2 on the carrying board 153, the food box 2 is removed, and finally the second-axis moving device 152 and the first-axis moving device 151 move the food box 2 to the receiving opening 116 and then into the oven 14.

The feeding slot 16 is formed in the second accommodation space 112 and disposed on a side of the oven 14 for storing the heated food box 2. Therefore, the direction for the robotic picking system 15 to move to the receiving opening 116 is perpendicular to direction of sending out the food box 2 from the oven 14. In addition, the present disclosure has a special design, wherein the feeding slot 16 has an upper meal pickup opening 161 and a lower meal pickup opening 162 formed at positions relative to the front side of the cupboard 11, and both sides of the feeding slot 16 have a partition board 163, and each of the partition boards 163 has a third rotary shaft 1631 and a third counterweight 1632, and the two partition boards 163 divide the feeding slot 16 into an upper area 164 and a lower area 165. After the first food box 2 falling into the lower area 165 presses and squeezes the two partition boards 163 by gravity, the two partition boards 163 can be rotated by using the third rotary shaft 1631 as a fulcrum, so that the next food box 2 falling into the feeding slot 16 is disposed in the upper area 164, and the two food boxes 2 will not be stacked together. After the food box 2 is removed, the two partition boards 163 resume their original positions by the two third counterweights 1632.

The conveyor board 17 has a first side edge 171 and a second side edge 172, and the conveyor board 17 installed between the oven 14 and the feeding slot 16, and the conveyor board 17 normally keeps the angle corresponding to the tilted moving tray 141, wherein the first side edge 172 is configured to be corresponsive to the moving tray 141, and the second side edge 172 is configured to be corresponsive to the feeding slot 16, so as to define the open/closed status of the feeding slot 16. After the food box 2 slides down obliquely from the moving tray 141 to the conveyor board 17, the food box 2 will continue sliding to the position of the second side edge 172, and the tilted conveyor board 17 sets the feeding slot 16 to the open status. After the food box 2 falls into the feeding slot 16, the conveyor board 17 will resume its original position to set the feeding slot 16 to the closed status. It is noteworthy that a second rotary shaft 173 is installed at the center of the conveyor board 17, and a second counterweight 174 is installed under the first side edge 171, and the second counterweight 174 uses the second rotary shaft 173 as a fulcrum to tilt the curved second side edge 172 upwardly and abut at the position of an opening of the feeding slot 16 to define the closed status. When the food box 2 slides along the conveyor board 17 to a position near the second side edge 172, the conveyor board 17 is turned downwardly by the weight, so that the food box 2 can obliquely fall into the feeding slot 16.

The present disclosure is characterized in that the three-axes moving robotic picking system 15 is provided for removing the food box 2 from a predetermined position of the racks 13 and moving the food box 2 to the oven 14 for heating, so that the space for cold storage and the space for placing the oven are separated from one another. In addition, the receiving opening 116 serves as a passage, so that the cold and hot energies on both sides will not interfere with each other. In addition to the conveying function of the robotic picking system 15, the seesaw design of the moving tray 141 and the conveyor board 17 can convey the food box 2 by a gravitational sliding method, and thus this disclosure has the effects of making turns for the delivery and simplifying the components. In addition, the operation of the robotic picking system 15 is integrated with the three-axis movements, so that the food boxes 2 can be stored by stacking vertically with respect to each other, and will not be limited the container size so much. The simplified mechanism and the separated design of the present disclosure can avoid the refrigeration and heating from interfering with each other, and thus the present disclosure has the effects of improving the refrigeration and heating efficiency and lowering the failure rate.

What is claimed is:

1. An automatic vending machine for boxed frozen and hot food, comprising:
a cupboard, with an interior partitioned into a first accommodation space and a second accommodation space;
a refrigeration device, disposed in the first accommodation space and the second accommodation space;
a plurality of racks, installed in pairs into the first accommodation space to form a whole piece of placing space, and a plurality of storage spaces between the two adjacent racks for placing at least one food box;
an oven, disposed in the second accommodation space, and a receiving opening being formed between the first accommodation space and the second accommodation space, and the oven being installed on a side of the receiving opening and provided for heating the food box that is put into the oven, and the oven having a moving tray therein, and a surface of the moving tray having a plurality of sliding balls, and an electromagnet being installed to a front end of the moving tray for attaching the moving tray after the electromagnet is driven, so that the moving tray is situated in a tilted status;
a robotic picking system, installed in the first accommodation space and disposed on a side of the placing space, and the robotic picking system comprising a first-axis moving device, a second-axis moving device and a carrying board, and the second-axis moving device being installed on the first-axis moving device, and the carrying board being installed on the second-axis moving device, and the first-axis moving device moving horizontally parallel to the placing space, and the moving direction of the first-axis moving device and the moving direction of the second-axis moving device being perpendicular to each other, such that after the first-axis moving device drives the second-axis moving device to move to a position for removing the food box, the second-axis moving device drives the carrying board to move towards the food box in order to carry and place the food box onto the carrying board, and finally the second-axis moving device and the first-axis moving device move the food box to the receiving opening and then into the oven;
a feeding slot, disposed in the second accommodation space and disposed on a side of the oven, for putting the heated food box; and
a conveyor board, having a first side edge and a second side edge, and installed between the oven and the feeding slot, and normally keeping at an angle after the moving tray is tilted, wherein the first side edge is configured to be corresponsive to the moving tray, and the second side edge is configured to be corresponsive to position of the feeding slot for setting the feeding slot to an open/closed status, such that after the food box slides down from the moving tray to the conveyor board, the food box will continue to slide to a position of the second side edge, such that the feeding slot will be in the open status after the conveyor board is tilted, and after the food box falls into the feeding slot, the conveyor board will resume its original position and the feeding slot will be in the closed status.

2. The automatic vending machine for boxed frozen and hot food as claimed in claim 1, wherein the receiving opening normally keeps a closed status, and after the receiving opening is opened, a tilt angle over 15 degrees occurs, and when the food box touches the receiving opening, the food box props open the receiving opening into a tilt state and slides into the oven.

3. The automatic vending machine for boxed frozen and hot food as claimed in claim 1, wherein the robotic picking system moves in a direction towards the receiving opening and this direction is perpendicular to the direction of sending out the food box from the oven.

4. The automatic vending machine for boxed frozen and hot food as claimed in claim 1, wherein the oven has a heating device installed thereon, and the moving tray is installed under the heating device, and a first rotary shaft is disposed at the bottom of the center of the moving tray, so that the moving tray can swing in a direction of sending out the food box by using the first rotary shaft as a fulcrum, and tilt after the electromagnet is attached to the moving tray.

5. The automatic vending machine for boxed frozen and hot food as claimed in claim 4, wherein the moving tray has a positioning rope installed at a front end thereof and configured to be corresponsive to the electromagnet, and a first counterweight disposed on the other side of the moving tray, so that after the electromagnet is released from the attached state, the first counterweight and the positioning rope resume the moving tray to its original position.

6. The automatic vending machine for boxed frozen and hot food as claimed in claim 1, wherein the conveyor board has a second rotary shaft installed at the center thereof, and a second counterweight is disposed under the first side edge, such that the second counterweight can use the second rotary shaft as a fulcrum to tilt the second side edge upwardly into a curved shape and abuts at an opening of the feeding slot to define a closed status, and when the food box slides along the conveyor board to a position near the second side edge, the conveyor board will be turned downwardly into an open status, so that the food box can fall into the feeding slot.

7. The automatic vending machine for boxed frozen and hot food as claimed in claim 1, wherein the feeding slot has an upper meal pickup opening and a lower meal pickup opening formed at a front side thereof and configured to be relative to the cupboard, and both sides of the feeding slot have a partition board, and each of the partition boards has a third rotary shaft and a third counterweight, and the two partition boards are provided for dividing the feeding slot into an upper area and a lower area, and after the food box falling into the lower area presses and squeezes the two partition boards by gravity, the two partition boards will be rotated by using the third rotary shaft as a fulcrum, so that the next food box falling into the feeding slot will be situated in the upper area, and after the food box is taken out, the two third counterweights resume the two partition boards to their original positions respectively.

8. The automatic vending machine for boxed frozen and hot food as claimed in claim 1, wherein the refrigeration device comprises a blowing device and a compressor, and the blowing device is disposed in the first accommodation space, and the compressor is disposed in the second accommodation space and at a position under the oven.

9. The automatic vending machine for boxed frozen and hot food as claimed in claim 1, wherein the cupboard comprises a first door panel installed thereon and configured to be relative to the first accommodation space, and a second door panel installed thereon and configured to be relative to the second accommodation space.

10. The automatic vending machine for boxed frozen and hot food as claimed in claim 9, further comprising an anti-theft lock installed on the first door panel, the anti-theft lock being manufactured with a company nameplate, and the anti-theft lock being locked and unlocked by a concave and convex buckling method.
